(19) United States
(12) Patent Application Publication
(10) Pub. No.: US 2013/0202103 A1
(43) Pub. Date: Aug. 8, 2013

(54) DIRECT CURRENT/DIRECT CURRENT CONVERTER FOR ACQUIRING STABILIZED LOW VOLTAGE AND TELEPHONE POWER SUPPLY CIRCUIT

(71) Applicants: Qiang Chen, Hangzhou Zhejiang (CN); Hao Chen, Yongkang Zhejiang (CN); Huijian Si, Hangzhou Zhejiang (CN); Gangjian Ying, Jinhua Zhejiang (CN)

(72) Inventors: Qiang Chen, Hangzhou Zhejiang (CN); Hao Chen, Yongkang Zhejiang (CN); Huijian Si, Hangzhou Zhejiang (CN); Gangjian Ying, Jinhua Zhejiang (CN)

(21) Appl. No.: 13/641,968

(22) PCT Filed: Jan. 5, 2011
(86) PCT No.: PCT/CN11/00020

§ 371 Date: Dec. 18, 2012

(30) Foreign Application Priority Data
Apr. 20, 2010 (CN) 201010152307.5

(51) Int. Cl. G05F 1/46

(52) U.S. Cl. CPC G05F 1/46
USPC 379/395.01; 323/282

(57) ABSTRACT

A Direct Current/Direct Current (DC/DC) converter for acquiring stabilized low voltage and a telephone power supply circuit based on the DC/DC converter are provided by the present invention. The DC/DC converter includes a power level circuit (1), which receives a dynamic voltage input from an outside circuit; a tank circuit (2), which uses energy-storage elements to store the electric energy outputted from the power level circuit and outputs the electric energy to a load; and a feedback control circuit (3), which receives the voltage from the output and feeds it back to the input of the tank circuit so as to control the connection and disconnection of the input of the tank circuit and further to control output voltage of the tank circuit. By the technical solution of the present invention, which uses the energy-storage inductance to store energy, limits the output, and acquires a stabilized low voltage from a wider range output voltage by using a feedback circuit, the power consumption is reduced, and the impact on the telephone is reduced at the time of picking up and/or hanging up the telephone.

### FIELD OF THE INVENTION

The present invention relates to a kind of DC(Direct Current/)/DC converter, in particular, to a DC/DC converter that can acquire stabilized low voltage and a voltage follower circuit based on the DC/DC converter.

### BACKGROUND ART

The voltage regulator such as the DC-DC voltage converter is used to supply stabilized voltage source for different kinds of electronic devices. Regarding to the battery management for some low-power devices (e.g. portable computer, portable mobile phone, etc.), the high-efficiency DC-DC converter is especially needed. The voltage regulator with ON/OFF control first converts the input voltage into a high frequency voltage signal. Then this high frequency input voltage signal is treated with filtering to generate a DC output voltage. The switching regulator generally comprises: a switch that alternately couples and decouples an input DC voltage source (e.g. battery) to the load (e.g. integrated circuit); an output filtering device which generally consists of an inductor and a capacitor is connected between the input voltage source and load for treating the output of switches with filtering, thus supplies a DC output voltage; a control device (e.g. pulse width modulator (PWM), pulse frequency modulator, etc.) that is used for controlling switches to acquire a relatively constant DC output voltage.

In some applications (e.g. radio frequency transmission, portable computer device, etc.), radio frequency or digital chip requires so high instantaneous power that the input source for the voltage regulator is inadequate to supply its required power. For instance, when it is applied to the ordinary fixed telephone, 6V voltage will be acquired for off-hook, while 50V voltage will be generated for on-hook. As a result, its static current is relatively higher, which will affect the state of serviceability for the normal telephone. Therefore, the drop in the output voltage for the voltage regulator affects the performance of the associated radio frequency or digital chip, which may cause the system to function improperly.

### SUMMARY

For the aforementioned defects, this invention offers a DC/DC converter to address the problem that the serviceability will be affected at the off-hook of telephone in existing technologies due to the super-high output power.

For this purpose, this invention adopts the following technical solutions:

a telephone power supply circuit acquiring relatively lower static current, used for rendering lower current output within the wider voltage supply range for the telephone, comprises:

a switching circuit whose input terminal is connected to the telephone line, with one output respectively connected to the high power consumption output circuit and the other output connected to the low power consumption output circuit ,is used to enable the external input voltage to switch between the low power consumption output circuit and the high power consumption output circuit;

said low power consumption output circuit further comprises a simulated inductance filter circuit which is further connected to a DC/DC converter used for supplying stabilized output voltage for the load telephone;

said DC/DC converter further comprises:

a power stage circuit, which is used for receiving the dynamic input voltage of external circuits;

a tank circuit, which is used for adopting electric energy outputted by the power stage circuit and outputting the electric energy to the load; the tank circuit further comprises a power inductor and a capacitor unit, and wherein said power inductor receives the output of the power stage circuit and stores the electric energy as well as constantly outputs stabilized voltage, and wherein one end of the power inductor is connected to the output of the power stage circuit and the other end to one end of said capacitor unit, and the other end of said capacitor is grounded; and

a feedback control circuit, receiving the output terminal voltage and feeding it back to the input terminal of the tank circuit, thus controlling the ON/OFF for the tank circuit input, thus controlling the output voltage of the tank circuit.

According to the telephone power supply acquiring relatively lower static current as stated in the better embodiment of this invention, said feedback circuit comprises resistive divider as well as a transistor and a power switch tube, and said resistive divider receives the load output and generates a voltage to said transistor, thus controls the input ON/OFF for the said tank circuit.

According to the telephone power supply acquiring relatively lower static current as stated in the better embodiment of this invention, said power stage circuit also comprises capacitor filter circuit.

According to the telephone power supply acquiring relatively lower static current as stated in the better embodiment of this invention, said power stage circuit also comprises a voltage stabilizing diode that is used for ensuring the voltage acquired by the tank circuit to be maintained stabilized.

This invention also provides a DC/DC converter acquiring stabilized low voltage, comprising:

a power stage circuit, which is used for receiving the dynamic input voltage of external circuits;

a tank circuit, which is used for adopting energy storage units to store the electric energy outputted by the power stage circuit and outputting this electric energy to the load; and

a feedback control circuit, receiving the output terminal voltage and feeding it back to the input terminal of the tank circuit, thus controlling the ON/OFF for the tank circuit input, thus controlling the output voltage of the tank circuit.

According to the DC/DC converter as stated in the better embodiment of this invention, said tank circuit comprises a power inductor and a capacitor unit, and said power inductor receives the output of the power stage circuit and stores the electric energy as well as constantly outputs stabilized voltage.

According to the DC/DC converter as stated in the better embodiment of this invention, one end of said power inductor is connected to the output of the power stage circuit and the other end to one end of said capacitor unit, and the other end of said capacitor unit is grounded.

According to the DC/DC converter as stated in the better embodiment of this invention, said feedback circuit comprises resistive divider and several transistors and a power switch tube, and wherein said resistive divider receives the load output and generates a voltage to said transistor, thus controls the input ON/OFF for the said tank circuit.

According to the DC/DC converter as stated in the better embodiment of this invention, said power stage circuit also comprises capacitor filter circuit.

According to the DC/DC converter as stated in the better embodiment of this invention, said power stage circuit also comprises a voltage stabilizing diode that is used for ensuring the voltage acquired by the tank circuit to be maintained stabilized.

In the technical solution applied to this invention, the power inductor is used to store energy and limit output, and the feedback circuit can be utilized to acquire relatively stabilized voltage from a wide range of output voltage, then reduce power consumption and effects upon the telephone at the time of off-hook and/or on-hook.

### BRIEF DESCRIPTION OF THE DRAWINGS

FIG. 1 is the schematic circuit block diagram of the DC/DC converter of this invention;

FIG. 2 is the implemented circuit diagram of the diagram as shown in FIG. 1;

FIG. 3 is the schematic diagram of the voltage follower circuit of this invention;

FIG. 4 is the implemented circuit diagram of the switching circuit as shown in FIG. 3;

FIG. 5 is the implemented circuit diagram of the simulated inductor filter circuit as shown in FIG. 3.

### DETAILED DESCRIPTION

The aforementioned drawings associated dwell on several optimally selected embodiments of this invention, but this invention is not only limited to these embodiments. The present invention encompasses any replacement, modification, equivalent method or proposal based on the essence and range thereof.

In order to make this invention fully known to the public, the following optimally selected embodiments of this invention specify particular details without which they can also be fully understood by technicians in this field. In addition, for avoidance of unnecessary confusions about the essentials of this invention, the known methods, processes, flows, units, circuits and to name more are not specified.

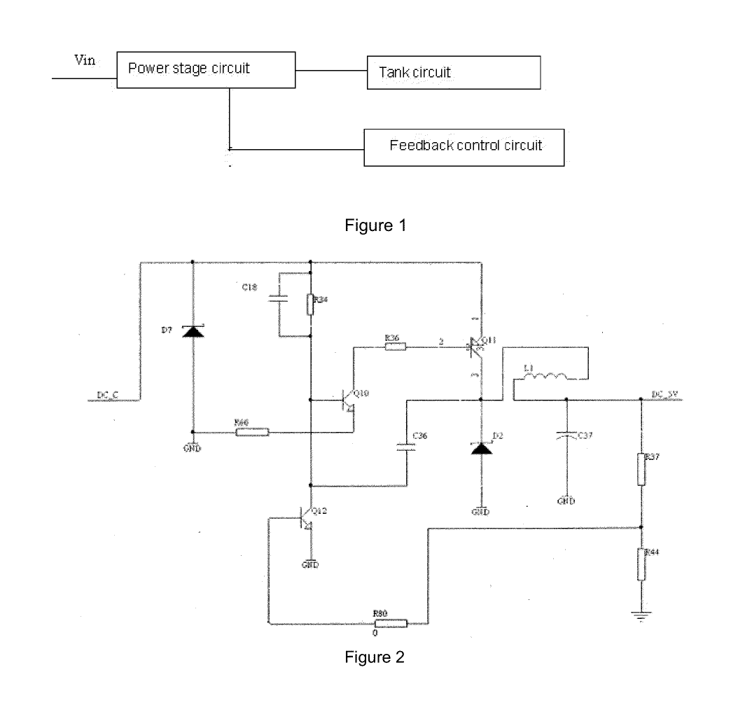

Referring to FIG. 1, it is the schematic block diagram on the DC/DC converter of this invention, as shown in FIG. 1, it comprises a DC/DC converter acquiring stabilized low voltage, wherein the DC/DC converter comprises: a power stage circuit that is used for receiving the dynamic input voltage of external circuits; a tank circuit that is used for adopting energy storage units to store the electric energy outputted by the power stage circuit and outputting this electric energy to the load; and a feedback control circuit, receiving the output terminal voltage and feeding it back to the input terminal of the tank circuit, thus controlling the ON and OFF for the tank circuit input, thus controlling the output voltage of the tank circuit.

Referring to FIG. 2, it is the implemented functional diagram of circuits shown in FIG. 1, it can be seen that the tank circuit of the DC/DC converter for this invention consists of a power inductor L1 and a Capacitor Unit C37, and the Power Inductor L1 receives the output of the power stage circuit and stores the electric energy as well as constantly outputs stabilized voltage; one end of Power Inductor L1 is connected to the output of the power stage circuit and the other end is electrically connected to one end of Capacitor Unit C37 and the other end of Capacitor Unit C3 is grounded.

The power stage circuit comprises a Speed-up Capacitor C18 that is further in parallel connection to a Resistor R34, so as to filter the input voltage and control the speed of charging and discharging, and the power stage circuit further comprising a Voltage Stabilizing Diode D7 that can protect subsequent circuits to acquire stabilized voltage during the gained voltage up to hector volt when the ringing is online.

The feedback circuit comprises a Resistive Divider R37, a Transistor Q12, a Transistor Q10 and a Power Switch Tube Q11. The Resistive Divider R37 receives the load output that is connected to the grid of the Transistor Q12 upon going through the voltage drop by a Resistor R80. The source electrode of the Transistor Q12 is connected to common nodes linking the grid of the Transistor Q10 with the non-input terminals of the Speed-up Capacitor C18 and a Resistor R34. The drain electrode of the Transistor Q12 is grounded. The source electrode of the Transistor Q10 is connected via a Resistor R36 to the grid of the Power Switch Tube Q11, and its drain electrode is grounded via a Resistor R66.

The source electrode of the Power Switch Tube Q11 is electrically connected to another common node of the Speed-up Capacitor C18 with the Resistor R34. The drain electrode of the Power Switch Tube Q11 is grounded via a Voltage Stabilizing Diode D2. A Capacitor C36 bridges between the common node linking the Voltage Stabilizing Diode D2 with the Power Switch Tube Q11 and the source electrode of the Transistor Q12.

The working process of the DC/DC converter will be stated as below. Upon the start-up, the external circuit renders the wide amplitude voltage; the Power Switch Tube Q11 is switched on; the Power Inductor L1 constantly stores the electric energy and periodically supplies voltage to the load. As the stored energy is increased, the voltage continuously rises. When the voltage exceeds the set value (e.g. 5V), the Transistor Q12 of the feedback control circuit is ON, the grid of the Transistor Q10 is grounded and then OFF, further controlling the OFF of the Power Switch Tube Q11, thus stopping supplying electric energy to the Power Inductor L1.

The Power Inductor L1 continuously discharges. The voltage divided by the Resistive Divider R37 continues to be decreased, and then the Transistor Q12 is OFF. Furthermore, the Power Switch Tube Q11 is ON and restores to the energy storage state.

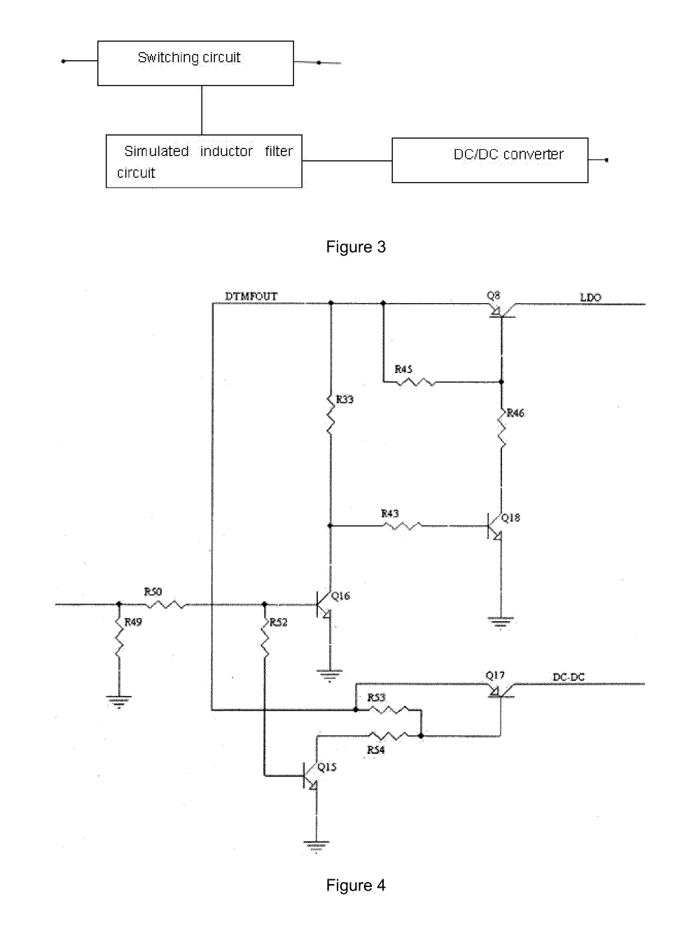

Referring to FIG. 3, this invention also provides a power supply circuit that renders relatively lower static current to the telephone, aiming at outputting relatively stabilized standby current in the condition of wider range voltage supply, i.e., static current, comprising: a switching circuit, used for enabling the external input voltage to switch between the low power consumption output circuit and high power consumption output circuit; the said low power consumption output circuit further encompasses a simulated inductor filter circuit that is further connected to a DC/DC converter for rendering stabilized output voltage to the load; the said DC/DC converter further includes: the power stage circuit, for receiving the dynamic input voltage of external circuits; the tank circuit, for adopting energy storage units to store the electric energy outputted by the power stage circuit and outputting this electric energy to the load; and the feedback control circuit, for receiving the output terminal voltage and feeds it back the input terminal of the tank circuit, thus controlling the ON and OFF for the tank circuit input, thus controlling the output voltage of the tank circuit.

Wherein, the principles of the switching circuit are shown in FIG. 4. When the input voltage is higher than the ON voltage of the Transistor Q16, the switching circuit is connected to the high power consumption output circuit; when the input voltage is lower than the ON voltage of the Transistor Q16, the low power consumption circuit works.

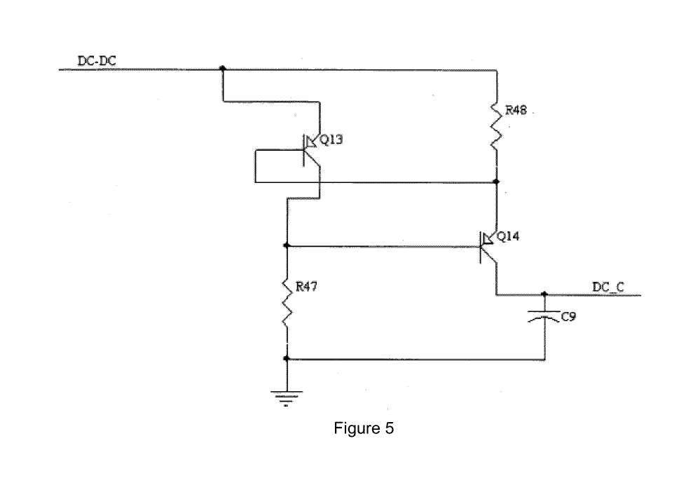

FIG. 5 is the implemented circuit diagram on the simulated inductor filter circuit whose working principles are as follows: a Capacitor C9 incorporating multiple resistors is used to filter the communication disturbance in switches; Capacitor C9 stores and periodically releases the electric energy in the extrinsic wave, thus achieving the filtering effects. The principles concerned are public technologies pertaining to the field. Therefore, it is not necessary to go into details.

Below description illustrates the detailed application of this invention in the telephone. Telephones supply power to circuits through the fixed telephone line. The fixed voltage supply by the telephone is 50-plus V for the on-hook state and 6-odd V for the off-hook dial tone; the current is 30 mA, short circuit current is more or less 35 mA; the fixed voltage supply by the telephone is 50-plus V for the on-hook ringing state. When other circuits fetch power from the telephone line, relatively higher static current will be generated, causing greater changes in the voltage generated by the telephone line, thus misjudging that the telephone is in the connected course.

As a result, before the telephone supplies power, the power supply circuit in this invention is connected in parallel, which can acquire relatively stabilized output voltage, without incurring circuit misjudgment due to the fact that the telephone line is engaged by other circuits, thus addressing the problem that external telephones fail to get through to fixed telephones.

The voltage follower circuit and DC/DC converter of this invention can be applied to ordinary telephones. In the off-hook or on-hook state, however wide the voltage input range (ranging from 6V-50V) is, low current output of 1 mA-60 mA and low voltage of 1.8V or 3.3 V can be acquired. The output efficiency concerned can reach more or less 70% and it is cost-effective, thus avoiding the situation where the telephone line is always misjudged to be engaged due to off-hook and on-hook.

The preferred embodiments of this invention are only used to assist in setting forth this invention. The preferred embodiments do not expatiate on all details, nor is this invention restricted to the said embodiment methods. Obviously, many modifications and changes can be made based on the contents contained in this instruction. This instruction selects and dwells on these embodiments for the purpose of better explaining the principles and practical application of this invention, thus enabling the technicians pertaining to the technical field to make better use of the present invention. This invention is only limited to the claims and all of their ranges and equivalents.

1. A telephone power supply circuit acquiring relatively lower static current, used for rendering lower current output within the wider voltage supply range for the telephone, comprising:
a switching circuit whose input terminal is connected to the telephone line, with one output connected to a high power consumption output circuit and the other output connected to a low power consumption output circuit, is used to enable the external input voltage to switch between the low power consumption output circuit and the high power consumption output circuit;
said low power consumption output circuit further comprising a simulated inductance filter circuit which is further connected to a DC/DC converter used for supplying stabilized output voltage for the load telephone;
said DC/DC converter further comprising:
a power stage circuit, which is used for receiving the dynamic input voltage of external circuits;
a tank circuit, which is used for adopting electric energy outputted by the power stage circuit and outputting the electric energy to the load, and the tank circuit further comprises a power inductor and a capacitor unit, and wherein said power inductor receives the output of the power stage circuit and stores the electric energy as well as constantly outputs stabilized voltage, and wherein one end of the power inductor is connected to the output of the power stage circuit and the other end to one end of said capacitor unit, and the other end of said capacitor is grounded; and
a feedback control circuit, receiving the output terminal voltage and feeding it back to the input terminal of the tank circuit, thus controlling the ON/OFF for the tank circuit input, thus controlling the output voltage of the tank circuit.

2. The telephone power supply circuit acquiring relatively lower static current as claimed in claim 1, characterized in that: said feedback circuit comprises a resistive divider, a transistor and a power switch tube, and said resistive divider receives the load output and generates a voltage to said transistor, thus controls the input ON/OFF for the said tank circuit.

3. The telephone power supply acquiring relatively lower static current as claimed in claim 1, characterized in that said power stage circuit also comprises a capacitor filter circuit.

4. The telephone power supply acquiring relatively lower static current as claimed in claim 1, characterized in that: said power stage circuit also comprises a voltage stabilizing diode that is used for ensuring the voltage acquired by the tank circuit to be maintained stabilized.

5. A DC/DC converter acquiring stabilized low voltage, comprising:
a power stage circuit, which is used for receiving the dynamic input voltage of external circuits;
a tank circuit, which is used for adopting energy storage units to store the electric energy outputted by the power stage circuit and outputting this electric energy to the load; and
a feedback control circuit, receiving the output terminal voltage and feeding it back to the input terminal of the tank circuit, thus controlling the ON/OFF for the tank circuit input, thus controlling the output voltage of the tank circuit.

6. The DC/DC converter as claimed in claim 5, characterized in that said tank circuit comprises a power inductor and a capacitor unit, and said power inductor receives the output of the power stage circuit and stores the electric energy as well as constantly outputs stabilized voltage.

7. The DC/DC converter as claimed in claim 5, characterized in that one end of said power inductor is connected to the output of the power stage circuit, and the other end electrically connected to one end of said capacitor unit, and the other end of said capacitor unit is grounded.

8. The DC/DC converter as claimed in claim 5, characterized in that said feedback circuit comprises a resistive divider and several transistors and a power switch tube, and wherein said resistive divider receives the load output and generates a voltage to said transistor, thus controls the input ON/OFF for the said tank circuit.

9. The DC/DC converter as claimed in claim 5, characterized in that said power stage circuit also comprises a capacitor filter circuit.

10. The DC/DC converter as claimed in claim 5, characterized in that said power stage circuit also comprises a voltage stabilizing diode that is used for ensuring the voltage acquired by the tank circuit to be maintained stabilized.
